(19) United States
(12) Patent Application Publication
(10) Pub. No.: US 2026/0251173 A1
(43) Pub. Date: Aug. 27, 2026

(54) ANCHORING ASSEMBLY, COMBINATION OF AN ANCHORING ASSEMBLY AND A STRUCTURAL ELEMENT, METHOD OF MANUFACTURING AN ANCHORING ASSEMBLY, METHOD FOR MOUNTING AN ANCHORING ASSEMBLY IN AN ELONGATE OPENING IN A STRUCTURAL ELEMENT

(71) Applicant: J. VAN WALRAVEN HOLDING B.V., MIJDRECHT (NL)

(72) Inventors: Frank NIJDAM, HARDERWIJK (NL); Marek JUZAK, MIJDRECHT (NL)

(21) Appl. No.: 18/872,642

(22) PCT Filed: Jun. 8, 2023
(86) PCT No.: PCT/EP2023/065362

§ 371 Date: Dec. 6, 2024

(30) Foreign Application Priority Data
Jun. 9, 2022 (NL) 2032108

(51) Int. Cl. F16B 37/04; F16B 7/18

(52) U.S. Cl. CPC F16B 37/046; F16B 7/18

(57) ABSTRACT

Anchoring assembly adapted to be pre-assembled in an elongate opening in a structural element, said anchoring assembly including:
an anchoring nut having a top side, a bottom side, and a threaded bore with a central axis that extends from the top side to the bottom side and that defines an axial direction, the nut furthermore having lateral sides that extend from the top side to the bottom side,
a spring made of metal, the spring having:
a spring portion extending from the bottom side of the nut, for resiliently supporting the anchoring assembly on a surface of the structural element that is in line with the elongate opening, a holding portion being in engagement with the nut for holding the spring on the nut, and a gripping portion extending from the top side of the nut for a user to grip during installation of the anchoring assembly.

### TECHNICAL FIELD

The invention relates to an anchoring assembly adapted to be pre-assembled in an elongate opening in a structural element, said anchoring assembly comprising an anchoring nut and a spring for resiliently supporting the anchoring assembly on a surface of the structural element that is in line with the elongate opening.

Such an anchoring assembly may also be called a channel nut, and is used to pre-assemble a nut in a structural element having the elongate opening. This pre-assembling of the nut allows for standard fasteners, e.g. hexagon screws, bolts, socket head cap screws, to be screwed into the threaded bore of the nut, e.g. to secure an object to the structural element.

The structural element may be a thin-walled hollow profile or rail, e.g. a channel element, preferably made of metal. The elongate opening may e.g. be a longitudinal slot that is defined in an upper side of the channel element as delimited between flanges which extend from respective sidewalls of the channel element towards each other. The elongate opening may alternatively be an elongate through hole in a wall of the structural element, e.g. a rectangular hole with straight transverse end edges at its head ends, i.e. at the short sides of the hole, but may also be a slotted hole, which has circular end edges.

### DESCRIPTION OF RELATED ART

Conventional channel nuts typically comprise a nut having a threaded bore and a spring extending downwardly from a bottom side of the nut. For example, when mounted in the channel element, the spring then biases a top side of the nut toward the flanges. See e.g. U.S. Pat. No. 7,246,547. These channel nuts are however cumbersome to mount in the structural element since the installer has either an uncomfortable grip on the channel nut and/or has to change his grip when he has to manually insert the channel nut in the opening, and rotate it about its central axis.

### SUMMARY OF THE INVENTION

It is an object of the invention to provide an alternative assembly of the type as mentioned at the outset. It is a further object of the invention to provide an anchoring assembly that facilitates ease of installation.

This object is achieved by an anchoring assembly adapted to be pre-assembled in an elongate opening in a structural element, said anchoring assembly comprising:
an anchoring nut having a top side, a bottom side, and a threaded bore with a central axis that extends from the top side to the bottom side and that defines an axial direction, the nut furthermore having lateral sides that extend from the top side to the bottom side,
a spring made of metal, the spring having:
   a spring portion extending from the bottom side of the nut, preferably the spring portion extends substantially along the central axis, for resiliently supporting the anchoring assembly on a surface of the structural element that is in line with the elongate opening,
   a holding portion being in engagement with the nut for holding the spring on the nut, and
   a gripping portion extending from the top side of the nut for a user to grip during installation of the anchoring assembly in the structural element,
wherein the spring portion, holding portion, and gripping portion are monolithic, and
wherein the gripping portion and the holding portion have been formed by bending the spring.

The gripping portion extending from the top side of the nut allows an installer to easily and/or sturdily grip the anchoring assembly for mounting it in the structural element. This facilitates the ease of installation of the anchoring assembly in the structural element and/or the ease of removal of the anchoring assembly from the structural element. Additionally, it allows for more precise installation of the anchoring assembly in the elongate opening in the structural element.

In particular, the anchoring assembly according to the invention allows for ease of (precise) installation of the anchoring assembly in an elongate opening having a length and width which is smaller than the length, and the nut of the assembly having a length and a width which is smaller than the length, wherein the length of the assembly is larger than the width of the elongate opening. The elongate opening having a longitudinal axis and a transverse axis, and the anchoring assembly having a first axis extending in a longitudinal direction and a second axis extending transverse to the first axis.

The gripping portion extending from the top side of the nut allows for gripping said gripping portion, and then manipulating the assembly such that the first axis of the assembly is aligned with the longitudinal axis of the elongate opening. Subsequently the anchoring assembly can be inserted in the opening, such that the spring portion engages a bottom surface of the structural element, the bottom surface being in line with the opening. Then the spring portion can be tensioned by exerting downward pressure whilst gripping the gripping portion such that the top side of the nut is below the opening, and rotating the assembly about its central axis, such that the second axis of the assembly is substantially aligned with the longitudinal axis of the elongate opening. Finally, the spring portion can be relieved, at least partially, by releasing said downward pressure whilst gripping the gripping portion such that the spring portion biases the top side of the nut towards an inner surface of the structural element adjacent to the elongate opening such that the top side of the nut is in supporting engagement with said inner surface of the structural element.

After mounting the anchoring assembly in the opening of the structural element, the gripping portion may be bent such that it substantially extends along the top side of the nut, preferably such that it does not cover the threaded bore.

The spring portion, holding portion and gripping portion being monolithic, and the gripping portion and the holding portion having been formed by bending the spring, is advantageous for manufacturing as it allows for a simple and efficient manufacturing process with few components.

In a preferred embodiment, the spring is made of a metal wire, which may e.g. be made of a spring steel. Then the spring is effectively a spring wire and the gripping portion is a bent wire portion. A spring wire is particularly advantageous for such a simple and efficient manufacturing process. Furthermore, this is a light-weight solution. Alternatively, the spring may e.g. be made of a sheet metal.

In a practical embodiment, the spring portion is a coil spring. Preferably, this coil spring is coaxial with the threaded bore, e.g. with the central axis thereof.

In a further embodiment, the gripping portion has been bent to be stiffer than the spring portion in the axial direction. This aids the precision of installation of the anchoring assembly as the gripping portion and the nut have a more stable position relative to each other when manipulating the assembly, whilst the anchoring assembly still has the desired spring resilience for resiliently supporting the anchoring assembly on a surface of the structural element that is in line with the elongate opening.

In yet another embodiment, the gripping portion is formed as an arch. This is particularly convenient for a user to grip. Furthermore, this is a particularly suitable embodiment for the gripping portion being bent such that it substantially extends along the top side of the nut, preferably such that it does not cover the threaded bore.

In an embodiment, the holding portion is in engagement with the bottom side of the nut and/or with one of the lateral sides of the nut.

In a further embodiment, the holding portion is also in engagement with the top side of the nut.

In a practical embodiment, the nut is provided with a recess, in particular a groove in which the holding portion is received. This allows for an engagement between the nut and the spring that prevents relative displacement therebetween, e.g. due to sliding. The nut and the spring may e.g. be in an interlocking engagement.

In a further practical embodiment, the holding portion is permanently fixed to the nut. For example, by riveting or clinching the holding portion to the nut. For clinching the holding portion would typically be received in a recess, e.g. a groove, in the nut, after which a fixing material is pressed against the holding portion—e.g. substantially perpendicular to the extension of the holding portion in said recess—with a punch-like tool, such that the holding portion is fixed to the nut body. The pressing of the fixing material may yield a further recess in the nut such that the fixing material lies recessed to, or flush with, an outer surface of the nut.

The invention further relates to a combination of an anchoring assembly according to the present application and a structural element.

In an embodiment, the structural element is a channel element which has a bottom, sidewalls extending from the bottom and an upper side opposite the bottom, wherein the upper side of the channel element comprises flanges which extend from the respective sidewalls towards each other and which delimit between them the elongate opening extending over the length of the channel element. Typically, the bottom of such a channel element is substantially flat. Further typically, the sidewalls of such a channel element extend at substantially right angles from the bottom. For such a channel element the elongate opening is a longitudinal slot.

In a further embodiment, in a mounted state the top side of the nut is in engagement with the flanges from below, and the gripping portion does not extend above the flanges. This is advantageous as it prevents interference from the gripping portion when e.g. assembling or securing objects to the channel element.

The invention further relates to a method for manufacturing an anchoring assembly according to the invention.

In an embodiment, wherein the spring is made of a metal wire, the method comprises the step of bending the spring by means of a wire bending process. The wire bending process may advantageously comprise the use of an automated wire bending machine, e.g. a CNC wire bending machine, for bending the spring.

In another embodiment, the spring is made of a sheet metal, e.g. from spring steel, by means of cutting and/or bending processes.

The invention further relates to a method for mounting an anchoring assembly according to the invention in an elongate opening in a structural element, the elongate opening having a length and a width which is smaller than the length, and the nut of the assembly having a length and a width which is smaller than the length, wherein the length of the assembly is larger than the width of the elongate opening,
wherein the elongate opening has a longitudinal axis and a transverse axis, and wherein the anchoring assembly has a first axis extending in a longitudinal direction and a second axis extending transverse to the first axis,
wherein the gripping portion is adapted to be gripped, e.g. between two fingers, the method comprising the steps of:
   gripping the gripping portion, manipulating the assembly such that the first axis of the assembly is aligned with the longitudinal axis of the elongate opening,
   inserting the anchoring assembly in the opening, such that the spring portion engages a bottom surface of the structural element, the bottom surface being in line with the opening,
   tensioning the spring portion by exerting downward pressure whilst gripping the gripping portion such that the top side of the nut is below the opening, and rotating the assembly about its central axis, such that the second axis of the assembly is substantially aligned with the longitudinal axis of the elongate opening,
   at least partially relieving the spring portion by releasing said downward pressure whilst gripping the gripping portion such that the spring portion biases the top side of the nut towards an inner surface of the structural element adjacent to the elongate opening such that the top side of the nut is in supporting engagement with said inner surface of the structural element and the threaded bore is in line with the opening.

The invention will be explained further with reference to the drawings, in which like reference symbols designate like parts. In these drawings:

### BRIEF DESCRIPTION OF THE DRAWINGS

FIG. 1A shows a view in perspective of a spring for an anchoring assembly according to the invention,

FIG. 1B shows a view in perspective of an anchoring assembly according to the invention having the spring of FIG. 1A.

FIG. 2A shows a view in perspective of a further spring for an anchoring assembly according to the invention,

FIG. 2B shows a view in perspective of another anchoring assembly according to the invention having the spring of FIG. 2A.

FIG. 3A shows a view in perspective of a yet a further spring for an anchoring assembly according to the invention,

FIG. 3B shows a view in perspective of yet another anchoring assembly according to the invention having the spring of FIG. 3A, and

FIGS. 4A-4C show a view in perspective of a combination of an anchoring assembly and a structural element according to the invention in various stages of installation of the anchoring assembly in said structural element.

### DETAILED DESCRIPTION

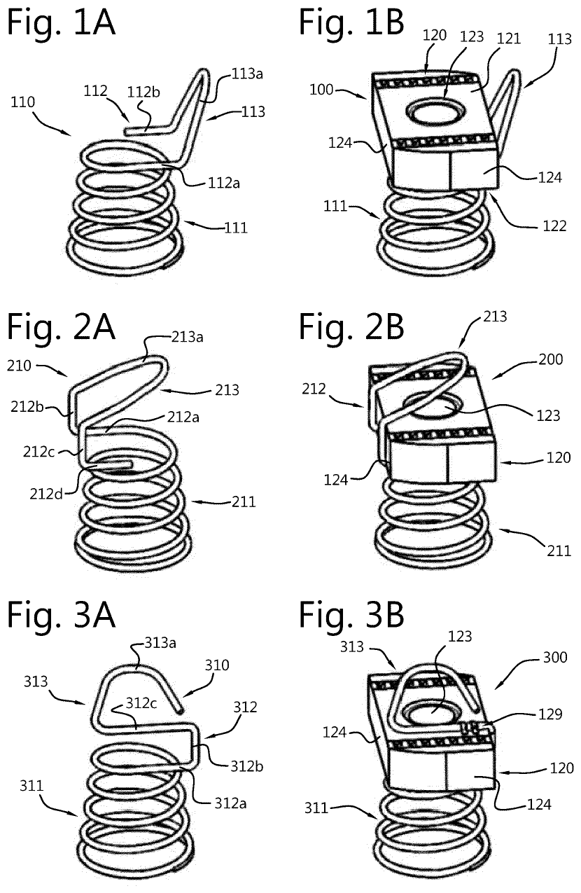

In FIG. 1A is shown a view in perspective of a spring 110 for an anchoring assembly according to the invention. The spring 110 is made of a metal wire, the metal wire may be made of spring steel.

In FIG. 1B is shown an anchoring assembly 100 adapted to be pre-assembled in an elongate opening in a structural element. The anchoring assembly 100 comprises an anchoring nut 120 having a top side 121, a bottom side 122, and a threaded bore 123 with a central axis that extends from the top side 121 to the bottom side 122 and that defines an axial direction. The nut 120 furthermore has lateral sides 124 that extend from the top side 121 to the bottom side 122.

The anchoring assembly 100 further comprises a spring 110 made of metal. The spring 110 has a spring portion 111 that extends from the bottom side 122 of the nut 120, for resiliently supporting the anchoring assembly 100 on a surface of the structural element that is in line with the elongate opening.

The spring 110 furthermore has a holding portion 112 that is in engagement with the nut 120 for holding the spring 110 on the nut 120. Here, the holding portion 112 is in engagement with the bottom side 122 of the nut. A gripping portion 113 extends from the top side 121 of the nut 120 for a user to grip during installation of the anchoring assembly 100 in the structural element.

The spring portion 111, holding portion 112, and gripping portion 113 are monolithic. The gripping portion 113 and the holding portion 112 have been formed by bending the spring. In FIGS. 1A-1B the spring portion 111 is a coil spring. The coil spring is coaxial with the threaded bore 123.

At an upper end the coil spring has a first straight part 112a of the holding portion 112 that extends along the bottom side 122 of the nut, e.g. abuts the nut and/or may be fixed thereto. The straight part 112a then is bent into an arch 113a or a loop to form the gripping portion 113. The arch 113a extends along and above a lateral side of the nut. At a lower end of the arch 113a the coil spring is bent into a second straight part 112b of the holding portion 112 that extends along the bottom side 122 of the nut, e.g. abuts the nut and/or may be fixed thereto.

The gripping portion 113 of FIGS. 1A-1B is formed as an arch and has been bent to be stiffer than the spring portion 111 in the axial direction.

In FIG. 2A is shown a view in perspective of a spring 210 for an anchoring assembly according to the invention. The spring 210 is made of a metal wire.

In FIG. 2B is shown an anchoring assembly 200 adapted to be pre-assembled in an elongate opening in a structural element. The anchoring assembly 200 comprises an anchoring nut 120 having a top side 121, a bottom side 122, and a threaded bore 123 with a central axis that extends from the top side 121 to the bottom side 122 and that defines an axial direction. The nut 120 furthermore has lateral sides 124 that extend from the top side 121 to the bottom side 122.

The anchoring assembly 200 further comprises a spring 210 made of metal The spring 210 has a spring portion 211 that extends from the bottom side 122 of the nut 120, for resiliently supporting the anchoring assembly 200 on a surface of the structural element that is in line with the elongate opening.

The spring 210 furthermore has a holding portion 212 that is in engagement with the nut 120 for holding the spring 210 on the nut 120 Here the holding portion 212 is in engagement with the bottom side 122 of the nut and one lateral side 124 of the nut. A gripping portion 213 extends from the top side 121 of the nut 120 for a user to grip during installation of the anchoring assembly 200 in the structural element.

The spring portion 211, holding portion 212, and gripping portion 213 are monolithic. The gripping portion 213 and the holding portion 212 have been formed by bending the spring. In FIGS. 2A-2B the spring portion 211 is a coil spring. The coil spring is coaxial with the threaded bore 123.

At an upper end the coil spring has a first straight part 212a of the holding portion 212 that extends along the bottom side 122 of the nut, e.g. abuts the nut and/or may be fixed thereto. The first straight part 212a then is bent—e.g. perpendicularly—into a first side part 212b that extends along a lateral side of the nut, e.g. abuts the nut and/or may be fixed thereto. The first side part 212b then is bent into an arch 213a or a loop that extends above the nut to form the gripping portion 213. At a lower end of the arch 213a the coil spring is bent into a second side part 212c of the holding portion 212 that extends along the bottom side 122 of the nut, e.g. abuts the nut and/or may be fixed thereto. The side part 212c is bent into a second straight part 212d of the holding portion 212 that extends along the bottom side 122 of the nut, e.g. abuts the nut and/or may be fixed thereto.

The gripping portion 213 of FIGS. 2A-2B is formed as an arch and has been bent to be stiffer than the spring portion 211 in the axial direction.

In FIG. 3A is shown a view in perspective of a spring 310 for an anchoring assembly according to the invention. The spring 310 is made of a metal wire.

In FIG. 3B is shown an anchoring assembly 300 adapted to be pre-assembled in an elongate opening in a structural element. The anchoring assembly 300 comprises an anchoring nut 120 having a top side 121, a bottom side 122, and a threaded bore 123 with a central axis that extends from the top side 121 to the bottom side 122 and that defines an axial direction. The nut 120 furthermore has lateral sides 124 that extend from the top side 121 to the bottom side 122.

The anchoring assembly 200 further comprises a spring 310 made of metal. The spring 310 has a spring portion 311 extending from the bottom side 122 of the nut 120, for resiliently supporting the anchoring assembly 300 on a surface of the structural element that is in line with the elongate opening.

The spring further has a holding portion 312 that is in engagement with the nut 120 for holding the spring 310 on the nut 120. Here the holding portion 312 is in engagement with the bottom side 122 of the nut, one lateral side 124 of the nut and the top side 121 of the nut. A gripping portion 313 extends from the top side 121 of the nut 120 for a user to grip during installation of the anchoring assembly 300 in the structural element.

The spring portion 311, holding portion 312, and gripping portion 313 are monolithic. The gripping portion 313 and the holding portion 312 have been formed by bending the spring. In FIGS. 3A-3B the spring portion 311 is a coil spring. In FIGS. 3A-3B the spring portion 111 is a coil spring. The coil spring is coaxial with the threaded bore 123.

At an upper end the coil spring has a first straight part 312a of the holding portion 312 that extends along the bottom side 122 of the nut, e.g. may be fixed thereto. The first straight part 312a then is bent—e.g. perpendicularly—into a side part 312b that extends along a lateral side of the nut, e.g. abuts the nut and/or may be fixed thereto. The side part 312b is bent—e.g. perpendicularly—into a second straight part 312c of the holding portion 312 that extends along the top side of the nut, e.g. abuts the nut and/or is fixed thereto with fasteners 129. The second straight part 312c then is bent into an arch 313a or loop that extends above the nut to form the gripping portion 313.

The gripping portion 313 of FIGS. 3A-3B is formed as an arch and has been bent to be stiffer than the spring portion 311 in the axial direction.

On the top side 121 of the nut 120, the holding portion is permanently fixed to the nut 120 by means of fasteners 129, e.g. by riveting, or clinching.

The springs 110, 210, 310 are made of a metal wire, which may be made of a spring steel or another suitably resilient metal. The springs are made by means of a wire bending process. In particular an automated wire bending machine (CNC wire bending machine) can advantageously be used to make the springs 110, 210, 310 in large amounts and cost effectively.

Although manufacturing the springs bent of a metal wire has advantages, it is also feasible to make springs of sheet metal, e.g. from spring steel, by for example cutting and bending processes.

Also making the spring of other resilient materials is possible, e.g. of a plastic or composite material.

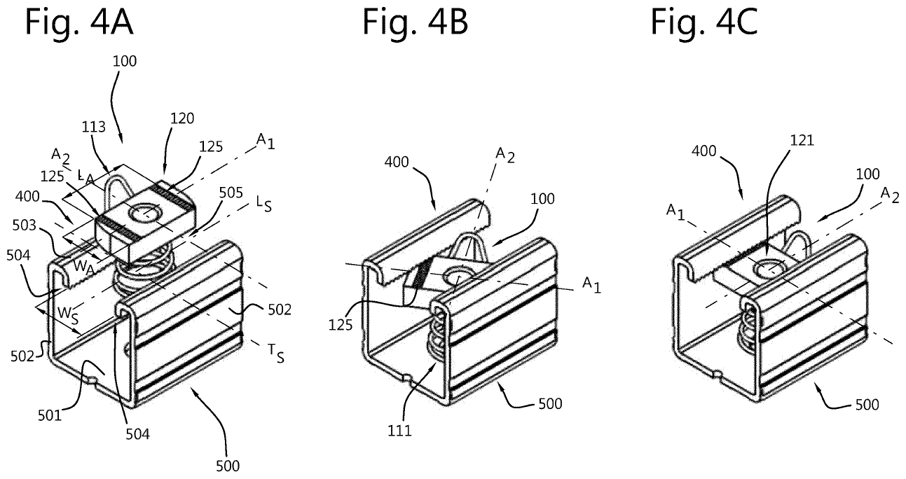

In FIGS. 4A-4C is shown a view in perspective of a combination 400 of the anchoring assembly 100 and a structural element 500 in various stages of installation of the anchoring assembly 100 in said structural element 500.

The structural element 500 is a channel element which has a bottom 501, sidewalls 502 extending from the bottom 501 substantially at right angles and an upper side 503 opposite the bottom 501, wherein the upper side 503 of the channel element 500 comprises flanges 503 which extend from the respective sidewalls 502 towards each other and which delimit between them an elongate slot 505 extending over the length of the channel element 500.

The particular channel element shown in the FIGS. 4A-4C is a profiled section element which has inwardly bent flanges and is known in the art as a “strut rail”. However, also other mounting rails, for example having a C-shaped cross-section can be used. Also other hollow profiled section elements can be used in which at least one of the walls can be provided with elongate through-holes to allow coupling with the anchoring assembly.

In any case, the structural element has an elongate opening 505. In the example of FIGS. 4A-4C opening 505 is a longitudinal slot. Alternatively, the elongate opening could be an elongate through hole. The longitudinal slot 505 having a length and a width W_{S} which is smaller than the length, and the assembly has a length L_{A} and a width W_{A} which is smaller than the length L_{A}, wherein the length L_{A} of the assembly is larger than the width W_{S} of the longitudinal slot.

The longitudinal slot 505 has a longitudinal axis Ls and a transverse axis T_{S}, and the anchoring assembly 100 has a first axis A₁ extending in a longitudinal direction and a second axis A₂ extending transverse to the first axis.

The gripping portion 113 of assembly 100 is adapted to be gripped, e.g. between two fingers.

In FIG. 4A is shown a view in perspective of the combination 400 in a pre-mounting state. The assembly 100 is or may be gripped by gripping portion 113 by a user. The assembly 100 is manipulated such that the first axis A₁ of the assembly 100 is aligned with the longitudinal axis L_{S} of the longitudinal slot 505. Then the assembly 100, for the combination with element 500, can be inserted in the longitudinal slot 505.

In FIG. 4B is shown a view in perspective of the combination 400 in an intermediate mounting state. The anchoring assembly 100 has been inserted in the longitudinal slot 505, such that the spring portion 111 engages the bottom surface 501 of the structural element 500, the bottom surface 501 being in line with the longitudinal slot 505. Further, the assembly 100 has been rotated about its central axis, such that eventually the second axis A₂ of the assembly 100 is substantially aligned with the longitudinal axis L_{S} of the elongate opening (shown in FIG. 4C). To achieve this, typically the spring portion 111 is tensioned by exerting downward pressure whilst the user is gripping the gripping portion 113 such that the top side 121 of the nut 120 is below the longitudinal slot 505.

In the mounted state shown in FIG. 4C the top side 121 of the nut 120 is in engagement with the flanges 503 from below, and the gripping portion 113 does not extend above the flanges 503. The spring portion 111 biases the top side 121 of the nut 120 towards an inner surface 504 of the structural element 500 adjacent to the longitudinal slot 505 such that the top side of the nut is in supporting engagement with said inner surface 504 of the structural element. Typically this is achieved by at least partially relieving the spring portion by releasing said downward pressure whilst gripping the gripping portion 113.

After mounting the anchoring assembly 100 in the longitudinal slot 505 of the structural element 500, the gripping portion 113 may be bent such that it substantially extends along the top side of the nut 120, preferably such that it does not cover the threaded bore 123.

In FIGS. 4A-4C the inner surface 504 of element 500 has serrations, and the nut 120 is provided with one or more indented portions 125 that engage said serrations in the mounted state.

1. An anchoring assembly adapted to be pre-assembled in an elongate opening in a structural element, said anchoring assembly comprising:
an anchoring nut having a top side, a bottom side, and a threaded bore with a central axis that extends from the top side to the bottom side and that defines an axial direction, the nut furthermore having lateral sides that extend from the top side to the bottom side,
a spring made of metal, the spring having:
a spring portion extending from the bottom side of the nut, for resiliently supporting the anchoring assembly on a surface of the structural element that is in line with the elongate opening,
a holding portion being in engagement with the nut for holding the spring on the nut, and a gripping portion extending from the top side of the nut for a user to grip during installation of the anchoring assembly in the structural element,
wherein the spring portion, holding portion, and gripping portion are monolithic, and wherein the gripping portion and the holding portion have been formed by bending the spring.

2. The anchoring assembly according to claim 1, wherein the spring is made of a metal wire.

3. The anchoring assembly according to claim 2, wherein the spring portion is a coil spring.

4. The anchoring assembly according to claim 1, wherein the gripping portion has been bent to be stiffer than the spring portion in the axial direction.

5. The anchoring assembly according to claim 1, wherein the gripping portion is formed as an arch.

6. The anchoring assembly according to claim 1, wherein the holding portion is in engagement with the bottom side of the nut and/or with one of the lateral sides of the nut.

7. The anchoring assembly according to claim 6, wherein the holding portion is also in engagement with the top side of the nut.

8. The anchoring assembly according to claim 1, wherein the nut is provided with a recess, in particular a groove, in which the holding portion is received.

9. The anchoring assembly according to claim 1, wherein the holding portion is permanently fixed to the nut.

10. The anchoring assembly according to claim 9, wherein the holding portion has been fixed to the nut by riveting or clinching.

11. A combination of the anchoring assembly according to claim 1, and a structural element.

12. The combination according to claim 11, wherein the structural element is a channel element which has a bottom, sidewalls extending from the bottom substantially at right angles and an upper side opposite the bottom, wherein the upper side of the channel element comprises flanges which extend from the respective sidewalls towards each other and which delimit between them the elongate opening extending over the length of the channel element.

13. The combination according to claim 12, wherein in a mounted state the top side of the nut is in engagement with the flanges from below, and the gripping portion does not extend above the flanges.

14. A method of manufacturing the anchoring assembly according to claim 1.

15. The method according to claim 14, wherein the method comprises the step of bending the spring by means of a wire bending process.

16. The method according to claim 15, wherein the wire bending process comprises the use of an automated wire bending machine, e.g. a CNC wire bending machine, for bending the spring.

17. The method according to claim 14, wherein the spring is made of a sheet metal, e.g. from spring steel, by means of cutting and/or bending processes.

18. The method for mounting the assembly according to claim 1 in an elongate opening in a structural element, the elongate opening having a length and a width which is smaller than the length, and the nut of the assembly having a length and a width which is smaller than the length, wherein the length of the assembly is larger than the width of the elongate opening,
wherein the elongate opening has a longitudinal axis and a transverse axis, and wherein the anchoring assembly has a first axis extending in a longitudinal direction and a second axis extending transverse to the first axis,
wherein the gripping portion is adapted to be gripped, e.g. between two fingers,
the method comprising the steps of:
gripping the gripping portion, manipulating the assembly such that the first axis of the assembly is aligned with the longitudinal axis of the elongate opening,
inserting the anchoring assembly in the opening, such that the spring portion engages a bottom surface of the structural element, the bottom surface being in line with the opening,
tensioning the spring portion by exerting downward pressure in the axial direction whilst gripping the gripping portion such that the top side of the nut is below the opening, and rotating the assembly about its central axis, such that the second axis of the assembly is substantially aligned with the longitudinal axis of the elongate opening,
at least partially relieving the spring portion by releasing said downward pressure whilst gripping the gripping portion such that the spring portion biases the top side of the nut towards an inner surface of the structural element adjacent to the elongate opening such that the top side of the nut is in supporting engagement with said inner surface of the structural element.
